(19) United States
(12) Patent Application Publication
(10) Pub. No.: US 2026/0326822 A1
(43) Pub. Date: Oct. 22, 2026

(54) STRUCTURAL COMPONENTS FOR A VEHICLE AND METHODS

(71) Applicant: AUTOTECH ENGINEERING S.L., Amorebieta-Etxano (ES)

(72) Inventors: Jordi CASTILLA MORENO, Hospitalet de Llobregat, Barcelona (ES); Marti MECA MARTÍNEZ, Santpedor, Barcelona (ES); Sergi MARQUEZ DURAN, Rajadell, Barcelona (ES)

(21) Appl. No.: 19/112,221

(22) PCT Filed: Sep. 21, 2023
(86) PCT No.: PCT/EP2023/076072

§ 371 Date: Mar. 14, 2025

(30) Foreign Application Priority Data
Sep. 22, 2022 (EP) 22382875.7

(51) Int. Cl. B62D 21/15; B62D 25/02; B62D 25/04; B62D 25/20

(52) U.S. Cl. CPC B62D 21/155; B62D 25/025; B62D 25/04; B62D 25/20

(57) ABSTRACT

The present disclosure relates to structural components for a vehicle framework at least partially configured for supporting bending loads. The structural component comprises a main member (110) defining a substantially U-shaped cross-section comprising a bottom wall (113), a first side wall (114) and a second side wall (116). Further, the main member (110) comprises a main soft zone (170) having lower mechanical properties than other zones of the main member (110). The main soft zone (170) comprises at a given longitudinal position a first soft portion (120) of substantially constant mechanical properties next to a second soft portion (140) of substantially constant mechanical properties. The present disclosure further relates to methods for manufacturing such structural components.

The present application claims the benefit of EP22382875.7 filed on Sep. 22, 2022.

The present disclosure relates to structural components for a vehicle framework, the structural components being at least partially configured for supporting bending loads. The present disclosure further relates to methods for manufacturing such structural components.

### BACKGROUND

Vehicles such as cars incorporate a structural skeleton designed to withstand the loads that the vehicle may be subjected to during its lifetime. The structural skeleton is further designed to withstand and absorb impacts, in case of e.g. collisions with other cars or road structures.

The demand for weight reduction in the automotive industry has led to the development and implementation of lightweight materials or components, and related manufacturing processes and tools. The demand for weight reduction is especially driven by the goal of a reduction of CO2 emissions. The growing concern for occupant safety also leads to the adoption of materials which improve the integrity of the vehicle during a crash while also improving the energy absorption.

A process known as Hot Forming Die Quenching (HFDQ) typically uses boron steel sheets to create stamped components with Ultra High Strength Steel (UHSS) properties, with tensile strengths of e.g. 1.500 MPa or 2.000 MPa or even more. The increase in strength allows for a thinner gauge material to be used, which results in weight savings over conventionally cold stamped mild steel components. Throughout the present disclosure UHSS may be regarded as a steel having an ultimate tensile strength of 1.000 MPa or more after a press hardening process.

In a HFDQ process, a blank to be hot formed may be heated to a predetermined temperature e.g. austenization temperature or higher (and particularly between Ac3 and an evaporation temperature of e.g. a coating of the blank). A furnace system may be used for this purpose. Depending on the specific needs, a furnace system may be complemented with additional heaters, e.g. induction or infrared. By heating the blank, the strength of the blank is decreased and deformability increases i.e. to facilitate the hot stamping process.

There are several known Ultra High Strength steels (UHSS) for hot stamping and hardening. The blank may be made e.g. of a boron steel, coated or uncoated, such as Usibor® (22 MnB5) commercially available from ArcelorMittal.

Hot Forming Die Quenching may also be called “press hardening” or “hot stamping”. These terms will be used interchangeably throughout the present disclosure.

Typical vehicle components that may be manufactured using the HFDQ process include: door beams, bumper beams, cross/side members, A/B pillar reinforcements, front and rear rails, seat crossmembers and roof rails.

Hot forming of boron steels is becoming increasingly popular in the automotive industry due to their excellent strength and formability. Many structural components that were traditionally cold formed from mild steel are thus being replaced with hot formed equivalents that offer a significant increase in strength. This allows for reductions in material thickness (and thus weight) while maintaining the same strength. However, hot formed components offer very low levels of ductility and energy absorption in the as-formed condition.

In order to improve the ductility and energy absorption in specific areas of a component, it is known to introduce softer regions within the same component. This improves ductility locally while maintaining the required high strength overall. By locally tailoring the microstructure and mechanical properties of certain structural components such that they comprise regions with very high strength (very hard), i.e. high ultimate tensile strength and high yield strength and regions with increased ductility (softer), i.e. lower ultimate tensile strength and lower yield strength and increased elongation before break, it may be possible to improve their overall energy absorption and maintain their structural integrity during a crash situation and also reduce their overall weight. Such soft zones may also advantageously change the kinematic behavior in case of a collapse of a component under an impact.

Known methods of creating regions with increased ductility (“softzones” or “soft zones”) in structural components of vehicles include the provision of tools comprising a pair of complementary upper and lower die units, each of the units having separate die elements (steel blocks). A blank to be hot formed is previously heated to a predetermined temperature e.g. austenization temperature or higher by, for example, a furnace system so as to decrease the strength i.e. to facilitate the hot stamping process.

The die elements may be designed to work at different temperatures, in order to have different cooling rates in different zones of the part being formed during the quenching process, and thereby resulting in different material properties in the final product e.g. soft areas which will generally have a lower ultimate tensile strength and a lower yield strength, but allow for more elongation before breaking. E.g. one die element may be cooled in order to quench the corresponding area of the component being manufactured at high cooling rates and to thereby reduce the temperature of the component rapidly and obtain a hard martensitic microstructure. Another neighboring die element may be heated in order to ensure that the corresponding portion of the component being manufactured cools down at a lower cooling rate, in order to obtain a softer microstructure, including e.g. bainite, ferrite and/or perlite. Such an area of the component may remain at higher temperatures than the rest of the component when it leaves the die.

Other methods for obtaining hot stamped components with areas of different mechanical properties include e.g. tailored or differentiated heating prior to stamping, and local heat treatments after a stamping process to change the local microstructure and obtain different mechanical properties. Yet further possibilities include the use of patchwork blanks, and Tailor Welded Blanks (TWB) combining different thicknesses and/or materials in blanks.

Several methods of differentiating heating prior to stamping are known. In an example, a nozzle or set of nozzles may discharge a fluid stream, e.g. compressed cooling air, towards a portion of the blank to be cooled e.g. while the bank is still in an oven. Other parts of the blank may be maintained at a higher temperature. This makes it possible to obtain a blank with a tailored temperature profile along its length and/or width. In some examples, the blank may undergo further heating in the oven before being subjected to the stamping process.

In other examples, an array of infrared heaters may be used which may be independently controlled to control temperatures along a blank.

Some elements of the structural skeleton of a car e.g. pillars (A-pillar, B-pillar, C-pillar), unitary door ring, a rocker, a floor, and a weave rocker may be designed specifically for supporting bending loads. That is, these parts are arranged such that in case of standard collision scenarios they are subjected to bending loads. These and other structural components may have one or more regions with a substantially U-shaped (also known as “hat”-shaped) cross section. These structural components may be manufactured in a variety of ways and may be made of a variety of materials. Lightweight materials that improve the energy absorption during a crash while also keeping the integrity of the vehicle are desired.

In addition to the Ultra High Strength Steels mentioned before, more ductile steels may be used in parts of the structural skeleton requiring energy absorption. Examples of ductile steels include Ductibor® 500, Ductibor ® 1000 and CRL-340LA.

UHSS may exhibit tensile strengths as high as 1.500 MPa, or even 2.000 MPa or more, particularly after a press hardening operation. Once hardened, a UHSS may have a martensitic microstructure. This microstructure enables an increased maximum tensile and yield strength per weight unit.

Some ductile steels may also be heated and pressed (i.e. used in a hot stamping process), but will not have a martensitic microstructure after the process. As a result, they will have lower tensile and yield strength than UHSS, but they will have a higher elongation at break.

Although ductile steel enables energy absorption by a structural component, controlling and predicting how the structural component may behave during a vehicle crash may not be easy. Moreover, the overall weight of the vehicle framework is preferably as low as possible to reduce fuel consumption. Also, enhancing energy absorption while maintaining a certain structural integrity of the structural component is not straightforward.

The present disclosure aims to provide improvements in the control of the deformation of and the energy absorption by a structural component for a vehicle framework when subjected to a load, in particular a bending load.

### SUMMARY

In a first aspect, a structural component for a vehicle framework is provided. The structural component is at least partially configured for supporting bending loads. The structural component comprises a main member defining a substantially U-shaped cross-section along at least a portion of the main member, the U-shaped cross-section comprising a bottom wall, a first side wall and a first outwardly extending side flange, a second side wall and a second outwardly extending side flange. The main member extends from a first end to a second end along a longitudinal direction of the main member. The main member comprises a main soft zone extending between a first longitudinal position and a second longitudinal position and having lower mechanical properties than other zones of the main member. Further, the main soft zone comprises a first soft portion of substantially constant mechanical properties, and a second soft portion of substantially constant second mechanical properties. At a longitudinal position between the first longitudinal position and the second longitudinal position, the first soft portion is arranged next to the second soft portion. The mechanical properties of the first soft portion are different from the mechanical properties of the second soft portion. Further, the mechanical properties are ultimate tensile strength and yield strength.

The introduction of a main soft zone comprising a first soft portion and a second soft portion, with respective first and second mechanical properties, provides a main member with the capacity to effectively absorb energy during a crash, while controlling the kinematics of deformation. The extent to which the soft zone intrudes towards the inside of a vehicle may be controlled by differentiating the mechanical properties in a side of the U-shaped cross-section from the mechanical properties in a bottom of the U-shaped cross-section.

Furthermore, the soft portions may include the side flanges which may be used to attach to other components. Breaking or tearing at the joints may be avoided, reduced or better controlled by controlling the mechanical properties in these side flanges to a desired level.

The main member may enable the absorption of more energy during the bending with high degree of deformation predictability. On the other hand, the remaining main member with higher mechanical properties may provide a limit to the deformation, preserving the internal space of the vehicle. Thus, safety for a vehicle passenger may be enhanced.

A bending load may be understood as a load or a component of a load acting substantially perpendicular to a length of the structural component in such a way as to attempt to bend the component. Components or regions in frameworks of cars that may be particularly subjected to bending loads include: B-pillars, door rings, rear rails, rockers, and e.g. integrated structures including e.g. a floor or a rear frame. Therefore, the examples disclosed herein may be especially beneficial when used in this type of components.

Throughout the present disclosure, “at least partially configured for supporting bending loads” may be understood as meaning that a part of a component, or the entire component is expected to absorb mainly bending loads in case of an impact or crash. I.e. even though other loads may occur as well, the bending loads are expected to be higher.

Also, throughout the present disclosure, references to the “mechanical properties of a portion” may be understood as the mechanical properties of the material forming said portion. Therefore, unless otherwise stated, comparisons of mechanical properties of portions, components, or others, are directed to the material and not to the geometry, or other particularities, of the same.

Higher mechanical properties may herein be understood as a higher ultimate tensile strength and/or a higher yield strength, whereas lower mechanical properties may be understood as a lower ultimate tensile strength and/or a lower yield strength. Ultimate tensile strength and yield strength are herein regarded as material properties of the material after the manufacturing process. Ultimate tensile strength and yield strength may be determined in standardized tensile strength tests, using e.g. A30, A50 or A80 specimens in a quasi-static load test.

The comparison between lower and higher mechanical properties should be made using the same test conditions and specimen size. To compare yield strengths of different portions, specimens formed with the same materials as the portions of the main soft zone may be prepared and tested in a Universal Testing Machine (UTM).

Throughout the present disclosure, a “portion with substantially constant mechanical properties” may be regarded as a portion made of the same material that has been subjected to the same heat treatment. The resulting mechanical properties may be substantially the same with the usual production tolerances. In examples, each portion may have an average magnitude for a mechanical property (such as hardness, yield strength or ultimate tensile strength), and local magnitudes within ±15 % deviation from the average magnitude.

Arranged “next to” with reference to soft portions of a soft zone may be interpreted generally as adjacent. It should be clear that it is possible that a (small) transition zone is formed between two adjacent soft portions.

In some examples, the second soft portion may be a bottom soft portion arranged at least partially at the bottom wall, and the first soft portion may be a side soft portion arranged at least partially in the first and second side flanges and/or in the first and second sidewalls.

In examples, the mechanical properties of the bottom soft portion may be lower than the mechanical properties of the side soft portion. In these examples, the side soft portion can limit the extrusion of the bottom portion of the U-shaped cross-section in case of an impact. The lower mechanical properties at the bottom soft portion may provide for increased energy absorption.

In some examples, the second soft portion may be arranged in the first side flange, and the first soft portion may be is arranged in the first sidewall. I.e. in some of these cases, the soft portion may be formed asymmetrically with respect to the U-shaped cross-section, in that a soft zone is only provided in one of the sides of the U-shape. In other examples, both sides of the U-shape may comprise a soft zone.

By providing a soft zone at only one side of the U-shape, local deformation to absorb energy in the case of impact is provided, while limiting the potential deformation of the overall structure. A soft zone in the flange area can further reduce local tearing or cracking.

In examples, the main soft zone of the structural component is formed by submitting the main soft zone to a different heat treatment than the other zones of the main member.

Further, in some examples, different portions of the main soft zone may be submitted to different heat treatments. For example, the bottom wall may be submitted to a first heat treatment and the side walls may be submitted to a second heat treatment different to the first heat treatment, or different parts of the sidewalls may be submitted to different heat treatments.

In some examples, a yield strength of the second soft portion is between 300-600 MPa, specifically between 400-500 MPa and a yield strength of the first soft portion is between 600-950 MPa, specifically between 650-800 MPa.

In some examples, the first and second side walls comprise a first and a second flange extending outwardly from the respective side walls. The flanges may be used to connect the main member with other components of the vehicle. Further, the flanges may increase the member resistance to bending deformations, i.e. the flanges may increase the moment of inertia of the main member.

In examples, the second soft portion is arranged at the bottom wall and at least a part of the first and second side walls. Further, the first soft portion is arranged at the first and second flanges. Doing so, the bottom wall and a part of the side walls may be of lower mechanical properties than the flanges. Thus, these walls may deform first in case of an impact, and the flanges may provide higher strength, substantially maintaining the integrity of the main member.

In some examples, the main soft zone of the structural component may further comprise a mid soft portion of substantially constant (third) mechanical properties which substantially connects the first soft portion to the second soft portion. The third mechanical properties may be higher than the (second) mechanical properties of the second soft portion. In examples, the second soft portion may be arranged at a flange adjacent to the sidewall and the mid soft portion may be arranged at a part of the side wall opposite to the bottom wall.

In examples, the structural component may comprise a secondary soft zone spaced apart from the main soft zone along the longitudinal direction and closer to the second end of the main member. The secondary soft zone may be different from the main soft zone. For example, the secondary soft zone may have higher mechanical properties than the main soft zone. In examples, the secondary soft zone may comprise more, or less, portions with different mechanical properties than the main soft zone.

In some examples, the main member of the structural component outside the soft zone(s) has an ultimate tensile strength of predominantly 1.000 MPa or more, specifically 1.200 MPa or more, and more specifically 1.500 MPa or more. The yield strength in the main member outside the main soft zone may be higher than in the main soft zone.

In some examples, the local mechanical properties of each of the first soft portion and the second soft portion varies less than 15 % about an average value of mechanical properties of the respective portion, and more specifically less than 10 %. The yield strength of a material represents the maximum stress than it can withstand before it begins to change shape permanently, i.e. it indicates the limit of elastic behavior and the beginning of plastic behavior when subjected to a load.

In some examples, a width of a transition zone between portions of the soft zone(s), i.e. between the first and second soft portions of the main soft zone or between the main member and the soft zone(s), may be smaller than 30 mm, specifically between 20 mm and 5 mm. The width of the transition zones depends on manufacturing parameters such as the difference in temperature between adjacent portions, or on the manufacturing procedure.

Further, in examples, a difference between an average yield strength of two adjacent portions may be greater than 10 %, specifically greater than 15 %, and possibly greater than 20 %.

In some examples, the main member may comprise regions made of hardened, specifically press hardened steel. The main member may comprise regions made of ultra high strength steel (UHSS) with ultimate tensile strength of 1.000 MPa, and specifically 1.500 MPa or more.

Also, the amount of energy absorption along a length of the main member may be tailored in different ways. For example, more energy may be absorbed when an area of a cross-section of the main member increases. Therefore, energy absorption may increase from a first cross-section of the main member closer to the first end to a cross-section which is farther away.

In some examples, the main member may comprise one or more ribs. The ribs may extend over the bottom wall, or one of the first side wall and the second side wall.

Throughout this disclosure a rib may be understood as an elongated, substantially straight part of a main member for local reinforcement. The ribs may be manufactured during a stamping process. In some examples, the ribs may be formed by using a patchwork blank, i.e. before the stamping process, a patch blank is welded (e.g. spot welded) to the main blank. In other examples, the ribs may be formed as deformations of the same main blank.

The presence of one or more ribs in the main member may help to adjust the deformation behavior of the structural component. The ribs, which are less ductile and more resistant than the main member, may help to create specific bending locations in the structural component. Accordingly, the deformation of the structural component can be optimized. Particularly when the structural component is configured to support bending loads, the energy absorption can be increased.

The number, position and extension of portions with different mechanical properties that the remainder of the main member, as well as the number, position and extension of ribs in the structural component may be selected according to a desired behavior of the structural component in terms of deformation, e.g. particularly under bending loads of the main member resulting from a (simulated) impact or crash.

In examples, the structural component may include an additional member attached to the main member. The additional member may e.g. be a plate, or cover attached at flanges of the main member. The additional member may also be similarly sized and shaped as the main member, i.e. the structural component is formed by two similar pieces.

In some examples, the additional member may be made of the same material and may be made by the same manufacturing process as the main member. In other examples, the additional member may be made in a different process and or a different steel. In some examples, the additional member may be cold formed with an appropriate cold form steel.

In some examples, the soft zone(s) including the aforementioned, first and second (and optionally further) soft portions may be formed in the additional piece as well.

In a further aspect, a method for manufacturing a structural component at least partially configured for supporting bending loads in order to obtain a structural component for a vehicle framework as described in this disclosure is provided.

The method comprises providing a main blank. The method further comprises heating the main blank at least partially to above an austenization temperature, wherein portions are heated differently than other portions of the main blank, and press hardening the heated main blank forming a main member of the structural component. The main member formed defines a substantially U-shaped cross-section along at least a portion of the main member, the U-shaped cross-section comprising a bottom wall, a first side wall and an outwardly extending first flange and a second side wall and an outwardly extending second flange. Further, the main member comprises a main soft zone having lower mechanical properties than other zones of the main member. Further, the main soft zone extends from a first longitudinal position to a second longitudinal position and comprises a first soft portion of substantially constant mechanical properties and a second soft portion of substantially constant mechanical properties. At a longitudinal position between the first and second longitudinal position (i.e. within the main soft zone), the first soft portion is arranged next to the second soft portion. The mechanical properties of the first soft portion are different from the mechanical properties of the second soft portion.

This method may improve the deformation behavior of a structural component configured for supporting bending loads and may enable adjusting how the structural component deforms during e.g. a car crash. Thus, energy absorption by the structural component may be enhanced.

A main blank is to be understood herein as a blank, e.g. a metal sheet or flat metal plate that will form the main member. The main blank may be made of hardenable steel, specifically boron steel. A thickness of the main blank may be typically between 1 and 2.5 mm.

In some examples of the method, the heating step comprises heating the main blank substantially homogenously above an austenization temperature, and subsequently cooling portions of the main blank, particularly below an austenization temperature. The portions that are cooled down may be adjacent to each other, i.e. an edge of one portion touches the edge of the adjacent portion.

In some examples of the method, the cooling may comprise blowing air through nozzles against the portions of the main blank to be cooled.

This approach to cool specific portion of the main blank may generate precisely defined temperature areas and gradients of temperature along and/or across the main blank. Thus, the cooling effect can be localized and the mechanical properties of the different portions may be precisely controlled. This allows for predictable and substantially constant mechanical properties within each portion and relatively small transition zones between them.

In some further examples, the cooling may comprise lowering the temperature of the cooled portions 100 degrees with respect to the other portions of the main member, and more specifically 200 degrees with respect to the other portions of the main member.

In some examples, the cooling may be performed using an array of nozzles or a matrix of nozzles. Thus, the nozzles may precisely define a portion of the main member to be cooled.

In examples, the nozzles may propel compressed air with an overpressure of at least 2 bar, specifically 3 bar and more specifically 4 bar. The overpressure should be understood as a difference in pressure between atmospheric pressure at normal conditions and the total pressure of the compressed air, i.e. static pressure plus dynamic pressure.

In some examples, the nozzles may comprise at least one tangential nozzle. The tangential nozzle may propel compressed air with a directional component that is substantially parallel to the processing plane, i.e. the surface of the component. Thus, this tangential nozzle may generate a flow seal, which may prevent the air from the other nozzles to reach a portion of the main blank. Therefore, tangential nozzles may be used to control the gradient of temperature along and/or across the main blank.

In examples, the nozzles may comprise a nozzle configured to generate a negative pressure area at a desired location inside the heating facility. The negative pressure area may be suitable for separating areas of different air temperature.

### BRIEF DESCRIPTION OF THE DRAWINGS

Non-limiting examples of the present disclosure will be described in the following, with reference to the appended figures, in which:

FIG. 1 schematically represents an example of a structural component for a vehicle at least partially configured for supporting bending loads.

FIG. 2 schematically illustrates the yield strength after quenching of an example of a structural component as a function of transverse position.

FIG. 3 schematically illustrates two cross-sections of another example of a structural component.

FIG. 4 schematically represents another example of a structural component for a vehicle at least partially configured for supporting bending loads.

FIG. 5 schematically illustrates a further example of a structural component for a vehicle at least partially configured for supporting bending loads.

FIG. 6 schematically represents another example of a structural component for a vehicle at least partially configured for supporting bending loads.

FIG. 7 schematically illustrates a further example of a structural component for a vehicle at least partially configured for supporting bending loads.

FIG. 8a schematically represents a perspective view of another example of a structural component for a vehicle at least partially configured for supporting bending loads.

FIG. 8b schematically represents a top view of the structural component illustrated in FIG. 8a.

FIG. 8c schematically represents a cross-section of the structural component illustrated in FIGS. 8a-8b .

FIG. 9 is a flow chart of a method for manufacturing a structural component at least partially configured for supporting bending loads.

The figures refer to example implementations and are only be used as an aid for understanding the claimed subject matter, not for limiting it in any sense.

### DETAILED DESCRIPTION OF EXAMPLES

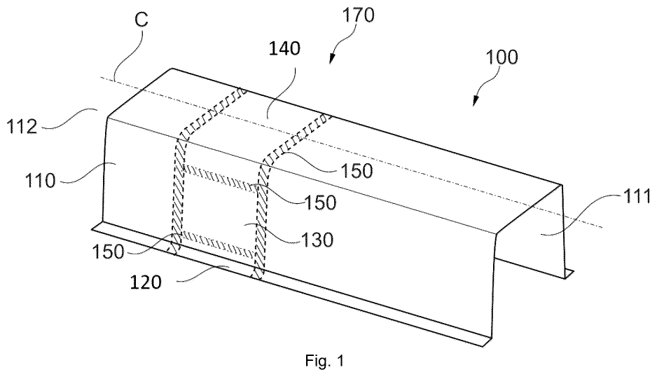

FIG. 1 schematically represents a structural component 100 for a vehicle configured, or at least partially configured, for supporting bending loads. The structural component 100 comprises a main member 110 that defines a substantially U-shaped cross-section along at least a portion of the main member, the U-shaped cross-section comprising a bottom wall, a first side wall and a second side wall.

The main member 110 extends from a first end 111 to a second end 112 along a longitudinal direction of the main member 110. The first end may be a bottom part of the main member, and the second end may be a top part, or vice versa. The first end may be a front end (in a vehicle longitudinal direction) and the second end may be rear end (in a vehicle longitudinal direction, or vice versa. The first end may be e.g. a left end, and the second end may be right end or vice versa, if the component is to be mounted generally along the transverse direction of the vehicle.

The main member 110 comprises a main soft zone 170 having lower mechanical properties than other zones of the main member 110. The main soft zone 170 extends from a first longitudinal position (closer to the first end) to a second longitudinal position (closer to the second end).

Further, the main soft zone 170 comprises a first soft portion 120 of substantially constant (first) mechanical properties, and a second soft portion 140 of substantially constant (second) mechanical properties. At a longitudinal position between the first longitudinal position and the second longitudinal position i.e., at a longitudinal position within the main soft zone, the first soft portion 120 is arranged next to the second soft portion 140. In examples, the first soft portion 120 may be submitted to a first heat treatment and the second soft portion 140 may be submitted to a second heat treatment. Further, differences between the first and second heat treatment may result in a first soft portion 120 with a material microstructure different than the second soft portion 140.

Further, the second mechanical properties (of the second soft portion) may be lower than the first mechanical properties (of the first soft portion). Such a configuration may be beneficial to limit the extent of intrusion in case of an impact.

For example, in the case of a B-pillar, the main soft zone may be arranged in a lower half of the B-pillar, and specifically may be arranged in the bottom 40 % of the B-pillar. The main soft zone in the B-pillar is generally provided in order to be able to absorb energy in the case of a side impact. The location of the soft zone will determine how the B-pillar will deform, and the main soft zone may particularly form a hinge like portion and the main soft zone is the area of the B-pillar that will generally protrude inwards more than other parts of the B-pillar in case of an impact. Providing the first soft portion with higher mechanical properties (i.e. higher yield strength and/or ultimate tensile strength) than the second soft portion may allow for energy absorption while at the same the inward intrusion in case of an impact is limited, thus improving occupant safety.

As illustrated in FIG. 1, the main soft zone 170 of the main member 110 may further comprise a mid soft portion 130 of substantially constant (third) mechanical properties.

In this illustrated example, the first soft portion 120 may be arranged at a part of the first and second side flanges and the mid soft portion 130 may be arranged at a part of the first and second side walls 114, 115, i.e. perpendicular to the centerline C. Further, the third mechanical properties may be lower than the second mechanical properties.

Thus, the main member 110 may comprise a main soft zone 170 including two or more distinctive portions in terms of mechanical properties, one adjacent to the other. The portions 120, 140, 130 may be arranged based on the mechanical properties, i.e. the portion with lowest mechanical properties at the bottom wall and the portion with the highest mechanical properties farthest from the bottom wall 113, and in particular in one or both of the side flanges.

Throughout the present disclosure, portions of the soft zone have been illustrated at one side of the structural member 100, however it should be understood that any type of soft zone illustrated may be, but do not necessarily have to be symmetrical with respect to a center line C of the structural member 100.

The main member 110 of the structural component 100 in the example of FIG. 1 outside the main soft zone 170 may have an ultimate tensile strength of predominantly 1.000 Mpa or more, specifically 1.200 MPa or more, and more specifically 1.500 Mpa or more.

In examples, the second soft portion 140 may have a yield strength of between 300-600 MPa, specifically between 400-500 MPa (e.g. an average around 450 MPa). In examples, the yield strength of the first soft portion is between 600-950 MPa, specifically between 650-800 MPa (e.g. an average around 725 MPa). The yield strength in the main member outside of the main soft zone may (predominantly) be higher than 1.000 MPa.

Further, the structural component 100 has a bottom wall 113 which may be substantially perpendicular to the first and second side wall 114, 115 (readily visible in FIG. 3). In further examples, the bottom wall 113 may define an angle different than 90 degrees with respect to the first and second side wall 114, 115.

Further, the radius of curvature between the bottom wall 113 and the first and second side wall 114, 115 may be adapted according to the specifications of the structural component 100, i.e. mechanical properties of the material used, maximum local strength desired and others.

As illustrated in e.g. FIG. 3, the structural component 110 may comprise a first and second side flange 116, 117 extending outwardly from the first and second side wall 114, 115 respectively. The flanges 116, 117 provide a convenient attachment point for e.g. riveting or spot welding to connect the structural component 100 with other parts of the vehicle, e.g. other components of the structural framework of the vehicle. The radius of curvature between the first and second side wall 114, 115 and the flanges 116, 117 may also vary according to the specifications of the structural component 110, as previously discussed.

In examples, a portion of the main soft zone 170, i.e. a first soft portion 120 or a mid soft portion 130, may be substantially located at the first and second flanges 116, 117.

The main member 110 may have a transition zone 150, i.e. between the different portions of the main soft zone 170, or between the main soft zone and harder zones of the main member 110 with a width smaller than 30 mm, specifically between 20 mm and 5 mm.

In some examples, the main member 110 may be made of a boron steel like Usibor®, e.g. Usibor® 1500 (22 MnB5 steel with or without protective coating), Usibor®2000 (37 MnB5 ) or any martensitic steel or ultra high strength steel (UHSS). Usibor®, is commercially available from ArcelorMittal.

Usibor® 1500 is supplied in ferritic-perlitic phase. It is a fine grain structure distributed in a homogenous pattern. Its mechanical properties are related to this structure. After heating, a hot stamping process and subsequent quenching, a martensite microstructure is created. As a result, tensile strength and yield strength increase noticeably.

The composition of Usibor® 1500 is summarized below in weight percentages (the rest is iron (Fe) and impurities):
Maximum carbon (C) (%): 0.25
Maximum silicon (Si) (%): 0.4
Maximum manganese (Mn) (%): 1.4
Maximum phosphorus (P) (%): 0.03
Maximum sulphur(S) (%): 0.01
Aluminium (AI) (%): 0.01-0.1
Maximum titanium (Ti) (%): 0.05
Maximum niobium (Nb) (%): 0.01
Maximum copper (Cu) (%): 0.20
Maximum boron (B) (%): 0.005
Maximum chromium (Cr) (%): 0.35

Usibor® 2000 is another boron steel, 37 MnB5, with even higher strength. After a hot stamping die quenching process, the yield strength of Usibor® 2000 may be 1300 MPa or more, and its ultimate tensile strength may be above 1800 MPa.

The composition of Usibor® 2000 is summarized below in weight percentages (rest is iron (Fe) and impurities):
Maximum carbon (C) (%): 0.36
Maximum silicon (Si) (%): 0.8
Maximum manganese (Mn) (%): 0.8
Maximum phosphorus (P) (%): 0.03
Maximum sulphur(S) (%): 0.01
Aluminium (AI) (%): 0.01-0.06
Maximum titanium (Ti) (%): 0.07
Maximum niobium (Nb) (%): 0.07
Maximum copper (Cu) (%): 0.20
Maximum boron (B) (%): 0.005
Maximum chromium (Cr) (%): 0.50
Maximum molybdenum (Mb) (%): 0.50

22 MnB5 and other boron steels may be presented with an aluminum-silicon coating in order to avoid decarburization and scale formation during the forming process.

Several 22 MnB5 steels are commercially available having a similar chemical composition. However, the exact amount of each of the components in a 22 MnB5 steel may vary slightly from one manufacturer to another. Other ultra high strength steels include e.g. BTR 165, commercially available from Benteler.

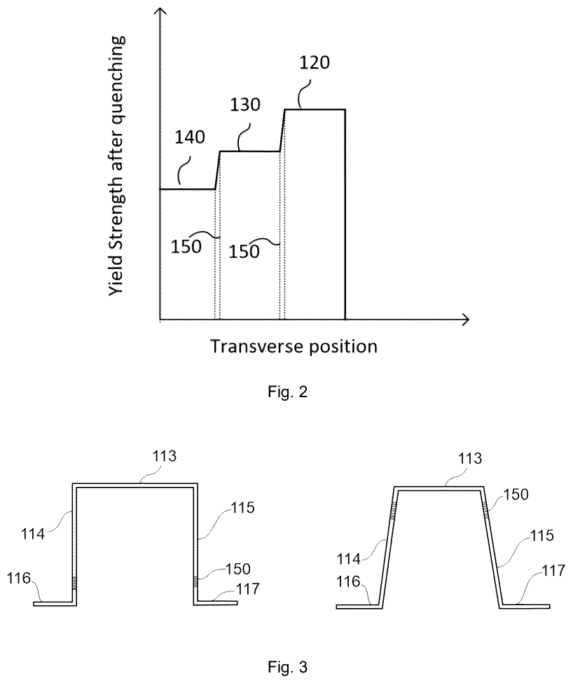

FIG. 2 is a simplified graph illustrating the average yield strength of a soft zone 170 of a structural component 100 along a transverse direction, which is perpendicular to a longitudinal direction (a center line along a longitudinal direction has been illustrated in FIG. 1). The horizontal axis represents the transverse position across the structural component 100 from the center line C in FIG. 1 to the end of flange 116. The vertical axis represents an average yield strength for a given cross-section after the structural component has been quenched, i.e. once it is at room temperature after press hardening.

Note that the reference numerals in FIG. 2 are associated with the features in FIG. 1. Thus, a region of the graph with a given reference numeral is not the feature itself but points to the yield strength of the corresponding feature in FIG. 1.

In the materials used when hot stamping the structural component of the present disclosure, yield strength (or tensile strength) and ductility are inversely correlated, i.e. as the microstructure of the material changes, yield strength and ultimate tensile strength increase when ductility decreases, and vice versa.

Thus, FIG. 2 shows that the yield strength at the bottom wall 113, i.e. second soft portion 140 is relatively low and nearly constant. Then, the yield strength of the main member 110 increases (and the ductility therefore decreases) at the first transition zone 150 to a higher level of yield strength for the mid soft portion 130. This change in mechanical properties occurs in a relatively short width, e.g. of the order of up to 20 mm. After this first transition zone 150, the main soft zone 170 comprises a first soft portion 120 of higher strength and lower ductility compared to the second soft portion 140 and mid portion 130.

The local yield strength of the soft zone is higher at a second transition zone 150 after the mid soft portion 130. The third plateau after the second transition zone 150 corresponds to the first soft portion 120, where the mechanical properties within the soft zone 170 are higher. As can be seen in FIG. 2, the yield strength gradient in different transition zones 150 may be different.

Note that FIG. 2 does not include specific values of strength or positions since it serves as a mere example for the present disclosure. Also, the width of some of the transition zones 150 may appear to be relatively large compared to the length of the portions of the main soft zone 170, but this has been done explicitly to illustrate potential differences in yield strength gradients. The microstructure that may be obtained can be controlled through appropriate heat treatments.

The difference between an average yield strength of two adjacent portions 120-130, 130-140 may be greater than 10 %, specifically greater than 15 % and even greater than 20 %. In examples, the difference between average yield strength of two adjacent portions may not be same as the difference between other two adjacent portions. For example, the difference between average yield strength of portions 120, 130 may be 10 %, whereas the difference between average yield strength of portions 130, 140 may be 15 %.

FIG. 3 schematically illustrates two cross-sections of an example of a structural component. These and other cross-sections may be part of the same structural component, i.e. the structural component may have a cross-section that changes along the longitudinal direction, or they may be cross-sections from different structural components.

Although not shown in the example of FIG. 3, the bottom wall 113 may be curved or comprise recesses or protrusions along the bottom. This also applies to the side walls 114, 115, which are not necessarily completely straight. The side walls 114, 115 may include straight portions with a curved transition zone between straight portions. In addition, the side walls 114, 115 may or may not be symmetrical. For example, a height of the first side wall 114 may be different from a height of the second side wall 115. In some examples, a height along the longitudinal direction of the first and/or second side walls 114, 115 may also vary. In examples, a width of the bottom wall 113 may be different from a height of the first and/or second side walls 114, 115. Other examples may include any combination of the above examples.

The flanges 116, 117 may be shaped and dimensioned to lie over specific vehicle components and may be used to join the structural component to other components such as other vehicle framework components.

As shown in FIG. 3, the transition zones 150 between the first soft portion and another soft portion (mid soft portion or second soft portion) may be located at different points along the transverse direction of the main member 110. For example, the transition zone 150 in the first cross-section (left figure) is relatively close to the flanges 116, 117, whereas the transition zone 150 in the second cross-section (right figure) is relatively close to the bottom wall 113. The transition zone 150 may be located below 20 % of a height of the side wall in the left example of FIG. 3. The location of the transition zone 150 may be established such that the specific kinematics of the structural component are achieved after a bending impact.

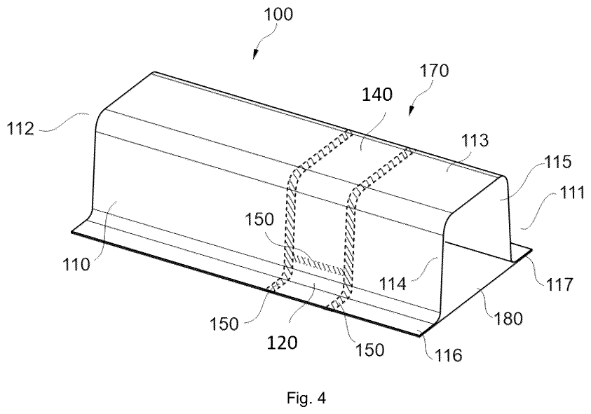

FIG. 4 schematically represents another example of a structural component 100 for a vehicle wherein the structural component is configured, or at least partially configured, for supporting bending loads. In this example, the main member 110 comprises a main soft zone 170 that has a lower yield strength and/or ultimate tensile strength, than the remainder of the main member 110. The main soft zone in this example comprises a first soft portion 120 and a second soft portion 140 separated by a transition zone 150 close to the first and second flanges 116, 117. The two portions 120, 140 may be more ductile than the remaining harder parts of the main member. In particular, the two portions may have a higher elongation at break, and/or an increased reduction in area before break, i.e. they may be more ductile than the remainder of the main member 110.

Further, the two portions 120, 140 have different mechanical properties. Other numbers of portions, i.e. four or more, as well as other relative sizes may be included in a structural component 100 according to the present disclosure.

In the illustrated example the local yield strength of each portion 120, 140 may vary less than 15 % about an average yield strength of the respective portion. I.e. the yield strength and/or ultimate tensile strength may be substantially constant within each of the portions 120, 140.

As shown in FIG. 4, the main member 110 may comprise a transition zone 150 between the soft zone 170 and the other zones of the main member with a width of less than 30 mm, specifically between 20 mm and 5 mm. The width of the transition zone 150 may depend on manufacturing parameters such as the difference in temperature between adjacent portions, or on the procedure followed to manufacture the structural component.

The structural component 100 comprises an additional member 180 attached to the main member 110. The additional member 180 may be a cover or plate. The additional member 180 may be attached at first and second side flanges 116, 117. At the same longitudinal position wherein the main soft zone 170 is formed in the main member 110, the additional member 180 may also comprise a soft zone. In other examples, no soft zone is provided in the additional member. In some examples, the steel of the additional member 180 may be different (e.g. cold form steel) from the steel of the member 110.

In other non-illustrated examples, the additional member may also have a U-shaped cross-section similar to the main member 110.

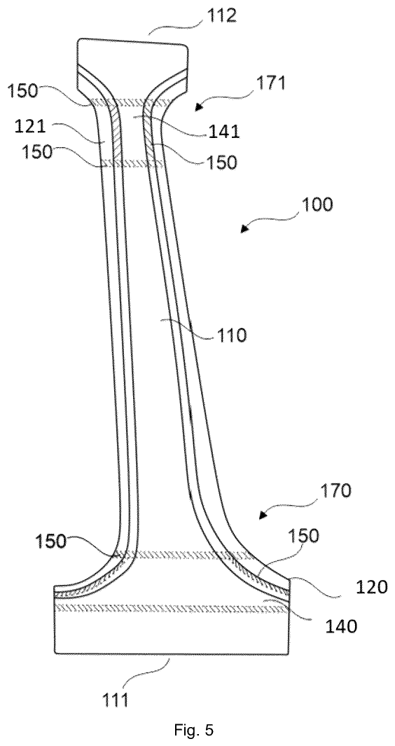

FIG. 5 schematically illustrates a further example of a structural component for a vehicle, wherein the structural component is at least partially configured for supporting bending loads. In this example, the structural component 100 is a B-pillar, but other vehicle components such as door rings, rear rails, and rockers among others may be also illustrative for the present disclosure. Large structural components of the vehicle, such as integrated structures including e.g. a floor or a rear frame, may have portions of the component designed to support bending loads and other portions of the components designed to support other types of loads, i.e. compressive loads.

In FIG. 5, a bending impact may be received in the main member 110 perpendicular to the longitudinal direction of the same. The main member 110 is a B-pillar and particularly a “central” B-pillar, or a load carrying member of the B-pillar. A complete B-pillar may include e.g. a further inner cover and a further outer cover.

Due to the introduction of the soft zone 170 with portions 120, 140 that have lower mechanical properties, i.e. lower tensile strength and yield strength, than the remainder of the main member 110, deformation of the main member 110 may start in and be concentrated in that portion instead of in any other region.

The main soft zone 170 in the B-pillar 100 may be located below 50 % of a height of the B-pillar, and specifically below 33 % of the height of the B-pillar. The main soft zone may have a width of at least 5 cm, and specifically at least 10 cm. The bottom most portion of the B-pillar 100 may be hard.

Also illustrated in FIG. 5, the structural component 100 may further comprise a secondary soft zone 171 spaced from the main soft zone 170 along the longitudinal direction. For example, a secondary soft zone 171 may have different mechanical properties from the main soft zone 170.

In examples, the secondary soft zone 171 may have higher mechanical properties than the main soft zone 170 may be located close to the second end 112 to promote a second deformation point. The secondary soft zone 171 may include more than two portions 121, 131, as previously discussed for the main soft zone 170. In examples, the transition zone(s) 150 between the two or more portions 121, 141 may be located at different transverse locations than in the main soft zone 170.

FIG. 6 schematically illustrates another example of a structural component 100 for a vehicle framework, wherein the structural component is at least partially configured for supporting bending loads. In this example, the structural component 100 is a unitary door ring of the vehicle. The door ring may be a front door ring, a rear door ring or a double door ring.

A front door ring extends from a hinge pillar and A-pillar to a B-pillar with a rocker portion connecting the B-pillar to the hinge pillar. A rear door ring extends from a B-pillar to the C-pillar, connected to each other by a rocker portion and a roof beam portion.

In this example, the double door ring includes a B-pillar portion, a rocker portion, a hinge portion, an A-pillar portion and a C-pillar portion. The double door ring may be formed by joining different blanks forming a combined blank and then by shaping the combined blank into a one-piece double door ring.

The main member 110 in this example makes up the door ring. The main member 110 comprises a main soft zone 170 and secondary soft zone 171 with three portions 120, 130, 140 that have lower yield strength and/or ultimate tensile strength than the remainder of the main member 110. The three portions 120, 130, 140 may be more ductile than the remaining harder parts of the main member 110. In particular, the three portions 120, 130, 140 may have a higher elongation at break, and/or increased reduction in area before break.

In other examples, the structural component may be a front door ring or a rear door ring. The front and rear door rings may comprise a main member comprising the main soft zone. In further examples, the front and/or the rear door ring may further comprise a secondary soft zone.

The main soft zone 170 may be located partially in the B-pillar portion 100 and partially in the rocker portion of the main member. In the B-pillar portion 100, the main soft zone 170 may be located below 50 % of a height of the B-pillar portion, and specifically below 33 % of the height of the B-pillar portion. The B-pillar portion 100 extends along a longitudinal (substantially vertical) direction and has a substantially U-shaped cross-section. The rocker portion of the main member also ahs a substantially U-shaped cross-section and extend along a substantially horizontal direction.

In particular, as may be seen in the example of FIG. 6, the main member 110 may comprise a main soft zone 170 located in a first sidewall and flange of the U of the main member 110 and a secondary soft zone 171 located in a second sidewall and second flange of the main member 110.

In the example of FIG. 6, the three portions 120, 130, 140 of the main soft zone 170 and the secondary soft zone 171 are arranged substantially symmetrically with respect to the U-shape. The second soft portion 140 in each of these soft zones is arranged at the first and second side flanges and the mid soft portions 130 and the first soft portions 120 are arranged at the first and second sidewalls.

In this example, the yield strength of the second soft portion 140 may be between 300-600 MPa, specifically between 300-500 MPa, the yield strength of the first soft portion 120 may be between 600-950 MPa, specifically between 650-800 MPa, and the yield strength of the mid portion 130 may be between 300-500 MPa, specifically between 400-500 MPa.

The door ring of the vehicle may receive a bending impact in the main member 110 perpendicular to the longitudinal direction of the main member. The door ring may effectively absorb the bending impact energy while controlling the kinematics of deformation and preserving the internal space of the vehicle.

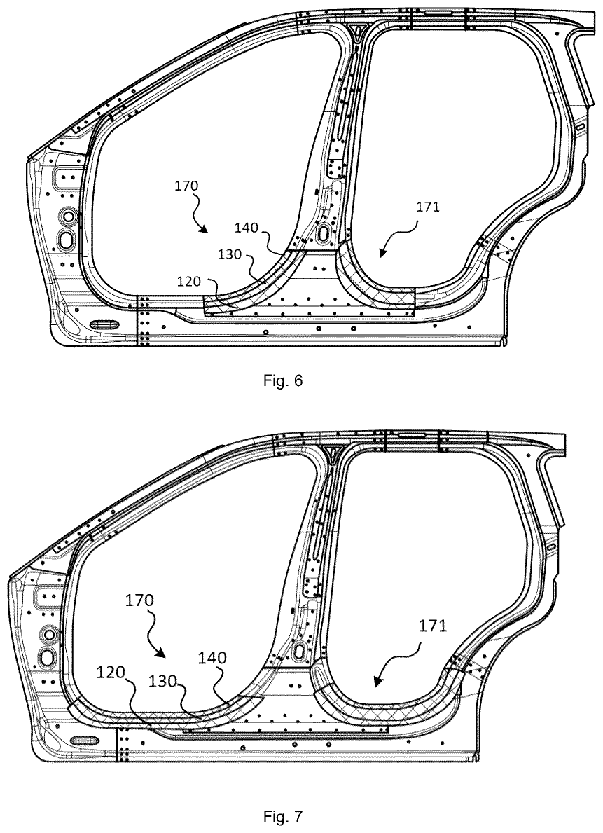

FIG. 7 schematically illustrates a further example of a one-piece double door ring of a vehicle which is at least partially configured for supporting bending loads.

In the example of FIG. 7, the main member 110 may comprise the rocker portion of the double door ring. The main member 110 may comprise a main soft zone 170 located in a top part of the rocker portion i.e. in a first sidewall and in a first flange of the main member 110. The main member 110 may further comprise a secondary soft zone 171 located in a top part of the rocker portion.

Similarly to the main member of FIG. 6, the main soft zone 170 of the member of the example of FIG. 7 comprises three portions 120, 130, 140 of different mechanical properties. The three portions 120, 130, 140 are arranged along a same longitudinal direction of the main member 110. The second soft portion 140 is arranged at a first flange, in particular the top flange of the rocker. The mid soft portion 130 and the first soft portion 120 are arranged at the top sidewall of the rocker.

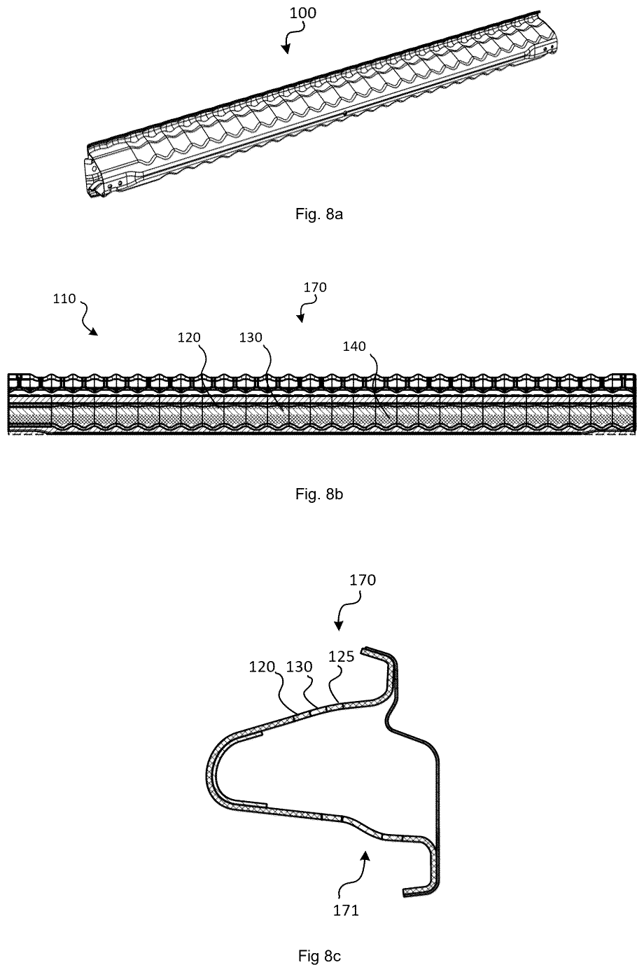

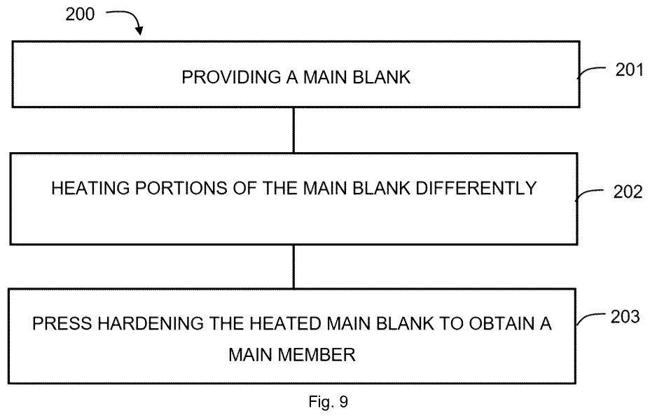

FIGS. 8a and 8b schematically illustrate a perspective view and a top view of another example of a structural component 100 for a vehicle framework, wherein the structural component is at least partially configured for supporting bending loads. The structural component 100 may be a tubular reinforcement of the vehicle. In this example, the structural component 100 is a reinforcement of the rocker of the vehicle.

In some examples, the rocker of a vehicle may usually be formed by a main member comprising a substantially U-shaped cross-section and an additional member attached to the main member. A closed space may be formed when attaching the main member and the additional member together, and the tubular reinforcement may be configured to be located in the closed space of the rocker of the vehicle. Many different rocker configurations are possible in which a rocker with a closed cross-section is provided, within which a reinforcement may be placed.

The reinforcement of the rocker comprises a main member 110 defining a substantially U-shaped cross-section. The reinforcement of the rocker also comprises an additional member attached to the main member 110, such that the main member and the additional member together form a closed cross-section. The additional member may be a cover or a plate.

In addition, FIG. 8c shows a cross-section of the reinforcement of the rocker illustrated in FIGS. 8a and 8b.

As schematically shown in FIGS. 8b and 8c, the reinforcement of the rocker may comprise a main soft zone 170 and a secondary soft zone 171 located in the first and second sidewalls of the U-shaped cross-section of the reinforcement of the rocker.

The main member 110 comprises a first soft portion 120 with first mechanical properties, a second soft portion 125 with second mechanical properties and a mid soft portion 130 with third mechanical properties. The first, second and mid soft portions 120, 140, 130 are arranged along a same longitudinal direction of the main member 110. In this example, the soft portions extend from a first end 111 of the main member 110 to a second end 112 of the main member, i.e. the main soft portion extends along the whole longitudinal length of the main member 110.

As schematically shown in FIGS. 8b and 8c, the first and second 120, 125 soft portions have the same mechanical properties. The mechanical properties of the mid soft portion 130 are different from the mechanical properties of the first and second soft portions 120, 140.

In this example, the yield strength of the first and second soft portions 120, 125 may be between 600-950 MPa, specifically between 650-800 MPa, and the yield strength of the mid portion 130 may be between 300-500 MPa, specifically between 400-500 MPa.

The rocker reinforcement of FIGS. 8a-8c may effectively absorb the bending impact energy while controlling the kinematics of deformation and preserving the internal space of the vehicle.

In some examples, ribs may be included in the main member 110 to further enhance the difference in strength between portions of the main member 110. In fact, features of the ribs including its number, shape, size, location and extension over the main member 110 may be tailored to adjust the behavior of the structural component 100 when subjected to a bending load. The ribs create harder and stiffer areas in the structural component 100. This way, the behavior of the main member 110 and the structural component 100 may be better controlled in a collision.

In another aspect of the present disclosure, a method 200 for manufacturing a structural component 100 at least partially configured for supporting bending loads as described throughout this disclosure, is provided. Any of the structural components herein provided may be manufactured in accordance with examples of such a method.

The method comprises, at block 201, providing a main blank. The method further comprises, at block 202, heating the main blank at least partially to above an austenization temperature, wherein adjacent first and second soft portions 120, 140 are heated differently than other portions of the main blank.

Furthermore, the method comprises, at block 203, press hardening the heated main blank forming a main member of the structural component 100. The main member 110 formed defines a substantially U-shaped cross-section comprising a bottom wall 113, a first side wall 114, a first side flange extending outwardly from the first side wall 114, and a second side wall 115 with an outwardly extending second side flange.

Further, the main member 110 comprises a main soft zone 170 having lower mechanical properties than other zones of the main member 110. Additionally, the main soft zone 170 comprises the bottom soft portion 120 of substantially constant first mechanical properties and the side soft portion 140 of substantially constant second mechanical properties.

Within the soft zone, at a given longitudinal position, the bottom soft portion 120 is arranged at least at the bottom wall 113 and the side soft portion 140 is arranged at least partially in the first and second side walls 114, 115 or in the first and second side flanges.

In examples, as mentioned before, the first mechanical properties of the bottom soft zone are lower than the second mechanical properties of the side soft portions. Within the different soft portions, the mechanical properties may be substantially constant.

Further, the method 200 may be adapted to form a main member 110 with any combination of the technical features previously discussed.

The main blank may be made of any type of hardenable steel, and particularly boron steel, as has been previously discussed for the structural component 100.

The heating step 202 of method 200 may comprise heating the main blank substantially homogenously above an austenization temperature, and subsequently cooling portions of the main blank particularly below an austenization temperature.

In examples, the main blank may be heated to above Ac3, and portions of the main blank may be cooled to a temperature below Ac3, and even below Ac1 before deforming the blank. The other portions may be maintained above Ac3 until the blank is deformed, or may be cooled temporarily but then heated up again to above Ac3.

For example, during a first phase of the heating step 202 the main blank may be heated substantially homogenously above Ac3 in a main furnace. Then, in a second phase of step 202, a portion of the main blank corresponding to a softzone (after forming) may be cooled to a temperature below Ac3, whereas other parts remain at higher temperature e.g. above Ac3. Additionally, in a third phase of step 202, the main blank may be heated up again maintaining the portion corresponding to a softzone below Ac3 and the remainder of the main blank maintaining a temperature above Ac3. The third phase of step 202 may serve to increase the temperature of the remainder of the main blank above Ac3 in situations wherein the overall temperature of the main blank has decreased during the second phase. The three phases of step 202 may be done in the same furnace or may be done in separate facilities downstream of the main furnace.

In some examples, the heating step 202 of method 200 may comprise blowing air through nozzles against the portions of the main blank to be cooled. The nozzles may be distributed in an array or in a 2D matrix to provide a more precise temperature profile along and/or across the main blank. This may be done in the same furnace where the main blank has been heated or may be done in a separate facility downstream of the main furnace.

The inventors have found that this type of method where a heated blank is partially cooled by means of pressurized nozzles allows to cool specific portions of the blank with a considerable small effect on the temperature of the remaining portions of the blank. This type of method allows to precisely control the temperature profile of the heated main member and the resulting material microstructure along the structural component. Further, this method represents a cost-effective approach to form the structural components of the present disclosure.

The cooling nozzles may set a temperature difference of at least 100 degrees, specifically at least 200 degrees, between at least a bottom soft portion 120 of the main member and the remaining of the main member 110. Further, several temperature differences between portions of the main member can be set. For example, it is possible to set three or more portions 120, 140 130 in the main member 110, each with different temperature.

In an example, a part of the blank that is to be fully hardened (most or all areas outside the main soft zone) may remain at a temperature of 900 °C or higher. The bottom soft portion may be reduced to a temperature of below Ac1, e.g. between 600 and 700 °C. The side soft portion 120 may have a higher temperature than the bottom soft portion but lower than the part of the blank to be fully hardened. The temperature of the side soft portion may be e.g. between 700 and 800 °C. While the temperature in portions of the blank is lowered, other portions may be kept above an austenization temperature, e.g. above 900 °C.

In some examples, the cooling may go down to lower ranges than mentioned above, and subsequently reheated at least to some extent. When the blank is positioned in a press tool, different portions of the blank may have different temperatures, whereas temperature within these positions are substantially constant.

Thus, the different temperatures can lead to different microstructures or strength properties being set in the respective portions of the main member 110, in particular during a subsequent rapid cooling (“quenching”), e.g. in the dies of the press tool.

In examples, the main member is shaped during the press hardening step 203 to form a component and at the same time is quenched to below 400 °C, or specifically below 300 °C.

In examples, the cooling nozzles may comprise at least one tangential nozzle. The tangential nozzle may propel compressed air with a directional component that is substantially parallel to the processing plane, i.e. the surface of the component. The tangential nozzle propels compressed at an angle different than zero against the surface of the component. For example, the tangential nozzle may be oriented such that the stream of air from the tangential nozzle and the vector normal to the surface of the component define an angle smaller than 30 degrees, and more specifically smaller than 15 degrees.

Thus, this tangential nozzle may generate a flow seal, which may prevent the air from the other nozzles to reach a given portion of the main blank. Therefore, tangential nozzles may be used to control the gradient of temperature along and/or across the main blank.

In some examples, the cooling nozzles may be mounted on a moving frame that may be able to displace and rotate individual nozzles with respect to the main blank.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A structural component for a vehicle framework, the structural component being at least partially configured for supporting bending loads, and comprising:
a main member extending from a first longitudinal position to a second longitudinal position and defining a substantially U-shaped cross-section along at least a portion of the main member, the U-shaped cross-section comprising a bottom wall, a first side wall with a first outwardly extending side flange, a second side wall, and a second outwardly extending side flange,
the main member extending from a first end to a second end along a longitudinal direction of the main member, wherein
the main member comprises a main soft zone, and a transition zone between the main soft zone and another zone of the main member, and
the entire main soft zone having lower mechanical properties than other zones of the main member, wherein
the main soft zone (170) comprises a first soft portion (120) of substantially constant mechanical properties and a second soft portion of substantially constant second mechanical properties; and
at a longitudinal position between the first longitudinal position and the second longitudinal position, the first soft portion is arranged next to the second soft portion and
wherein the mechanical properties of the first soft portion are different from the mechanical properties of the second soft portion,
wherein the mechanical properties are ultimate tensile strength and yield strength.

2. The structural component of claim 1, wherein the mechanical properties of the second soft portion are lower than the mechanical properties of the first soft portion.

3. The structural component of claim 2, wherein a yield strength of the second soft portion is between 300-600 and a yield strength of the first soft portion is between 600-950 MPa.

4. The structural component of claim 1, wherein the main soft zone is formed by submitting the main soft zone to a different heat treatment than the other zones of the main member.

5. The structural component of claim 1 any wherein the second soft portion is a bottom soft portion arranged at least partially at the bottom wall, and the first soft portion is a side soft portion arranged at least partially in the first and second side flanges and/or in the first and second sidewalls.

6. The structural component of claim 5, wherein the bottom soft portion is arranged at the bottom wall and at least a part of the first and/or second side walls.

7. The structural component of claim 6, wherein the side soft portion is arranged at the first and second side flanges and at least partially in the first and/or second side walls.

8. The structural component of claim 1, wherein the second soft portion is arranged in the first side flange, and the first soft portion is arranged in the first sidewall.

9. The structural component of claim 8, wherein the main soft zone does not extend into the bottom of the U-shaped cross-section.

10. The structural component of claim 1, wherein at the longitudinal position, the main soft zone comprises a mid soft portion of substantially constant mechanical properties, substantially connecting the first soft portion to the second soft portion.

11. The structural component of claim 1, wherein the main member outside the main soft zone predominantly has an ultimate tensile strength of 1,200 MPa or more.

12. The structural component of claim 1, wherein a local yield strength of each of the first and second soft portions varies less than 15% about an average yield strength of the first and second soft portions respectively.

13. The structural component of claim 12, wherein a difference between an average yield strength of the first and second soft portions is greater than 20%.

14. The structural component of claim 1, further comprising an additional member attached to the main member.

15. The structural component of claim 14, wherein the additional member comprises a soft zone at a longitudinal position between the first and the second longitudinal positions.

16. The structural component of claim 1, wherein the structural component is or forms part of any of a B-pillar, a door ring, a rear rail, a rocker and integrated structures including a floor or a rear frame.

17. (canceled)

18. (canceled)

19. (canceled)

20. (canceled)

21. A structural component for a vehicle framework, the structural component being at least partially configured for supporting bending loads, and comprising:
a main member extending from a first longitudinal position to a second longitudinal position and defining a substantially U-shaped cross-section along at least a portion of the main member, the U-shaped cross-section comprising a bottom wall, a first side wall with a first outwardly extending side flange, a second side wall, and a second outwardly extending side flange,
the main member extending from a first end to a second end along a longitudinal direction of the main member, wherein
the main member comprises a main soft zone, and a transition zone between the main soft zone and another zone of the main member, and
the entire main soft zone having lower mechanical properties than the other zones of the main member, wherein
the main soft zone comprises a first soft portion of substantially constant mechanical properties and a second soft portion of substantially constant second mechanical properties; and
at a longitudinal position between the first longitudinal position and the second longitudinal position, the first soft portion is arranged next to the second soft portion, and
wherein the mechanical properties of the first soft portion are different from the mechanical properties of the second soft portion,
wherein the mechanical properties are ultimate tensile strength and yield strength, and wherein
the second soft portion is a bottom soft portion arranged at the bottom wall and at least a part of the first and/or second side walls, and the first soft portion is a side soft portion and is arranged at the first and second side flanges and at least partially in the first and/or second side walls.

22. The structural component of claim 21, wherein a yield strength of the second soft portion is between 300-600 MPa, and a yield strength of the first soft portion is between 600-950 MPa, and wherein
the main member outside the main soft zone predominantly has an ultimate tensile strength of 1,200 MPa or more.

23. A structural component for a vehicle framework, the structural component being at least partially configured for supporting bending loads, and comprising:
a main member extending from a first longitudinal position to a second longitudinal position and defining a substantially U-shaped cross-section along at least a portion of the main member, the U-shaped cross-section comprising a bottom wall, a first side wall with a first outwardly extending side flange, a second side wall, and a second outwardly extending side flange,
the main member extending from a first end to a second end along a longitudinal direction of the main member, wherein
the main member comprises a main soft zone, and a transition zone between the main soft zone and another zone of the main member, and
the entire main soft zone having lower mechanical properties than the other zones of the main member, wherein
the main soft zone comprises a first soft portion of substantially constant mechanical properties and a second soft portion of substantially constant second mechanical properties; and
at a longitudinal position between the first longitudinal position and the second longitudinal position, the first soft portion is arranged next to the second soft portion, and
wherein the mechanical properties of the first soft portion are different from the mechanical properties of the second soft portion,
wherein the mechanical properties are ultimate tensile strength and yield strength, and wherein
the second soft portion is arranged in the first side flange, and the first soft portion is arranged in the first sidewall, and wherein
the main soft zone does not extend into the bottom of the U-shaped cross-section.

24. The structural component of claim 23, wherein a yield strength of the second soft portion is between 300-600 MPa, and a yield strength of the first soft portion is between 600-950 MPa, and wherein
the main member outside the main soft zone predominantly has an ultimate tensile strength of 1,200 MPa or more.
